(19) United States
(12) Patent Application Publication
(10) Pub. No.: US 2025/0252425 A1
(43) Pub. Date: Aug. 7, 2025

(54) SECURE TRANSACTION CARD

(71) Applicant: Multi Packaging Solutions, Inc., Atlanta, GA (US)

(72) Inventor: Kenneth L GLINERT, Chappaqua, NY (US)

(21) Appl. No.: 18/434,330

(22) Filed: Feb. 6, 2024

(51) Int. Cl. G06Q 20/34

(52) U.S. Cl. CPC G06Q 20/348; G06Q 20/354

(57) ABSTRACT

A prepaid card assembly that includes packaging and a prepaid card. The prepaid card is at least partially enclosed within the packaging. The prepaid card includes a barcode. The prepaid card is coupled to the packaging such that, upon removal of the prepaid card from the packaging, a portion of the barcode of the prepaid card remains coupled to the packaging to render the barcode of the prepaid card unscannable.

### TECHNICAL FIELD

This disclosure relates to prepaid cards, and more particularly, to counterfeit preventative prepaid card packaging.

### BACKGROUND

Prepaid cards, such as gift cards, have become more prevalent and popular in many consumer industries. For example, a customer may visit a local hardware or grocery store and purchase prepaid gift cards for a variety of categories, including restaurants, clothing, hardware, groceries, electronics, online stores, or a combination thereof. As popularity of prepaid cards continues to increase so does the need for adequate protection of the prepaid cards. Often, a fraudulent individual (i.e., a “fraudster”) may walk into a store that sells prepaid cards and place counterfeit barcodes over the cards' barcodes or identification information. When a genuine customer loads a card with money at the store's register, the counterfeit barcode is scanned, thereby transferring the customer's money to the fraudster's account. As a result, the fraudster quickly spends or moves the funds before the customer can use the prepaid card, thereby rendering the prepaid card worthless.

To combat the increase in prepaid card fraud, prepaid card and packaging manufacturers have developed a variety of ways to prevent tampering, to indicate if a prepaid card packaging has been tampered with, or both. For example, prepaid card barcodes have become increasingly more complex by including basic gradients or colors to prevent fraudsters from printing similar barcodes on a conventional printer. However, fraudsters continue to improve their methods of replicating barcodes, thereby demanding even further improvement in tamper-preventative measures currently being taken.

### SUMMARY

In one aspect of the present disclosure, a prepaid card assembly is disclosed. The prepaid card assembly includes packaging and a prepaid card at least partially enclosed within the packaging. The prepaid card includes a barcode. The prepaid card is coupled to the packaging such that, upon removal of the prepaid card from the packaging, a portion of the barcode of the prepaid card remains coupled to the packaging to render the barcode of the prepaid card unscannable.

In some implementations, the packaging may define a cutout, and the barcode of the prepaid card may be visible through the cutout when the prepaid card is coupled to the packaging.

In some implementations, the packaging may include a warning label located adjacent to the barcode of the prepaid card when the prepaid card is coupled to the packaging. The warning label may include reference information about the barcode of the prepaid card to identify counterfeit or tampered with packaging.

In some implementations, the prepaid card may include a hologram disposed on the barcode of the prepaid card, and the barcode of the prepaid card may be configured to be scanned through the hologram.

In some implementations, the barcode of the prepaid card may include a color gradient to vary colors of the barcode.

In some implementations, the prepaid card assembly may further include an adhesive label disposed between the packaging and the prepaid card to couple the prepaid card to the packaging. The adhesive label may be coupled to the prepaid card over at least a portion of the barcode of the prepaid card. An adhesive strength between the adhesive label and the packaging may be greater than an adhesive strength between the adhesive label and the prepaid card such that, when the prepaid card is removed from the packaging, the adhesive label remains coupled to the packaging. The adhesive label may include an adhesive pattern located between packaging adhering regions of the adhesive label. The adhesive pattern may be coupled to the prepaid card over at least a portion of the barcode of the prepaid card and the packaging adhering regions may be coupled to the packaging. The packaging adhering regions may be free of the adhesive pattern. The packaging adhering regions and the adhesive pattern may be separated by cut lines of the adhesive label.

In another aspect of the present disclosure, a prepaid card assembly is disclosed. The prepaid card assembly includes packaging, a prepaid card, and an adhesive label. The packaging includes a first panel and a second panel. The prepaid card is at least partially located between the first panel and the second panel. The prepaid card also includes a barcode. The adhesive label is disposed between the prepaid card and the first panel to couple the prepaid card to the packaging. Upon removal of the prepaid card from the packaging, the adhesive label is configured to remain coupled to the first panel and a portion of the barcode of the prepaid card is configured to remain coupled to the adhesive label such that the barcode of the prepaid card is unscannable.

In some implementations, the packaging may define a cutout. The barcode of the prepaid card may be visible through the cutout when the prepaid card is coupled to the packaging. A portion of the adhesive label may be located between the barcode of the prepaid card and the cutout.

In some implementations, the prepaid card may include a hologram disposed on the barcode of the prepaid card. The adhesive label may be coupled to the prepaid card over at least a portion of the barcode of the prepaid card and the hologram.

In some implementations, an adhesive strength between the adhesive label and the packaging may be greater than an adhesive strength between the adhesive label and the prepaid card such that, when the prepaid card is removed from the packaging, the adhesive label remains coupled to the packaging. Upon removal of the prepaid card from the packaging, the portion of the barcode of the prepaid card may be configured to remain coupled to the adhesive label such that the portion of the barcode is visible through the cutout.

In some implementations, the packaging may include reference information about the barcode of the prepaid card and that may be located adjacent to the barcode of the prepaid card when the prepaid card is coupled to the packaging. The reference information may be configured to identify counterfeit or tampered with packaging based upon one or more features of the barcode of the prepaid card. The one or more features of the barcode of the prepaid card may include a color of the barcode of the prepaid card, a design of a hologram disposed over the barcode of the prepaid card, or both.

In another aspect of the present disclosure, a prepaid card assembly is disclosed. The prepaid card assembly includes packaging, a prepaid card at least partially enclosed within and coupled to the packaging, and an adhesive label disposed between the packaging and the prepaid card to couple the prepaid card to the packaging. The packaging defines a cutout. The prepaid card includes a barcode and a hologram is disposed over at least a portion of the barcode. The hologram and the barcode are visible through the cutout when the prepaid card is coupled to the packaging. The adhesive label is coupled to at least a portion of the barcode of the prepaid card such that, upon removal of the prepaid card from the packaging, the portion of the barcode of the prepaid card is removed from the prepaid card and remains coupled to the packaging.

In some implementations, upon removal of the prepaid card from the packaging, the portion of the barcode of the prepaid card may remain visible through the cutout.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A is a front view of a prepaid card assembly.

FIG. 1B is a close-up view of a barcode of a prepaid card of the prepaid card assembly of FIG. 1A.

FIG. 2A is a perspective view of a prepaid card assembly prior to insertion of a prepaid card into packaging of the prepaid card assembly.

FIG. 2B is a cross-sectional view of a prepaid card assembly.

FIG. 2C is a cross-sectional view of a prepaid card assembly.

FIG. 2D is a cross-sectional view of a prepaid card assembly.

FIG. 3A is a perspective view of a prepaid card assembly after removal of a prepaid card from packaging of the prepaid card assembly.

FIG. 3B is a front view of an adhesive label of the prepaid card assembly of FIG. 3A.

### DETAILED DESCRIPTION

The present teachings generally relate to a prepaid card assembly. The prepaid card assembly may include packaging that is configured to securely house one or more items, such as a prepaid card. The packaging of the prepaid card assembly may prevent tampering with the one or items within the packaging (e.g., the prepaid card) prior to a rightful owner opening the packaging. For example, the packaging may help easily identify if a prepaid card has been removed from the packaging or if a barcode of the prepaid card has been altered in any manner. As such, a rightful owner (i.e., a genuine consumer) of the prepaid card or a retail store selling the prepaid card may recognize that the prepaid card may no longer be valid and dispose of the prepaid card.

As stated above, the prepaid card assembly may include or contain one or more items, such as a prepaid card. The prepaid card may be a gift card or other loadable and/or scannable item contained within the packaging of the prepaid card assembly. As such, the teachings herein are not particularly limited to any one item contained within the packaging of the prepaid card assembly.

As described further below, a barcode of the prepaid card may be designed to help with such deterrence. The barcode of the prepaid card may be at least partially visible when the prepaid card is located within the packaging to allow a retail associate to scan the barcode. As a result, the barcode may be at risk of duplication. For example, fraudsters may often attempt to adhere a counterfeit barcode directly over the barcode of the prepaid card, thereby making a genuine customer inadvertently preload a “dummy” account tied to the fraudster. Similarly, fraudsters may often remove the prepaid card from the packaging and replace the prepaid card with a replicate, thereby making a genuine customer inadvertently preload the “dummy” account tied to the fraudster. It is envisioned that the prepaid card assembly described herein deters the aforementioned tampering. Additionally, it is envisioned that the prepaid card assembly described herein may provide easy identification of fraudulent activity and/or counterfeit prepaid cards.

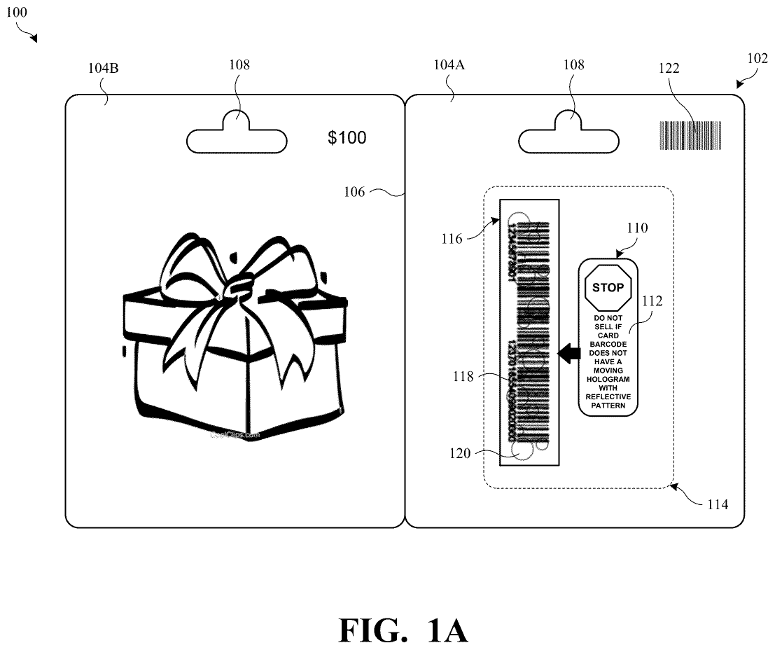

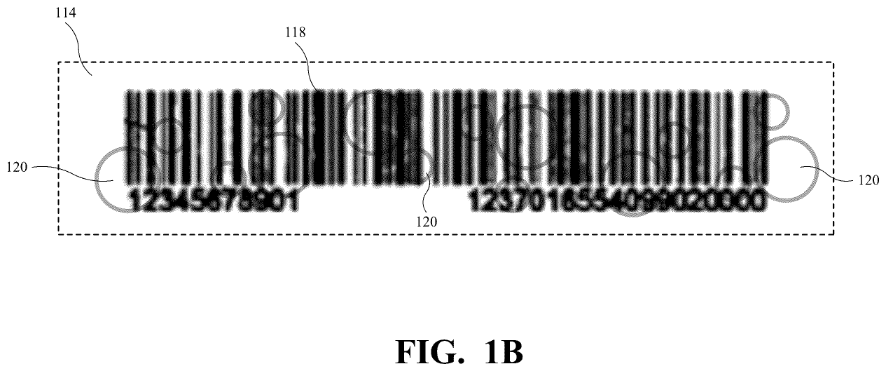

Turning now to the figures, FIG. 1A illustrates a front view of a prepaid card assembly 100. The prepaid card assembly 100 may include packaging 102 and a prepaid card 114 at least partially enclosed within the packaging 102. For example, the packaging 102 may include a first panel 104A adjoined to a second panel 104B by a fold line 106 so that the first panel 104A and the second panel 104B may be folded relative to one another along the fold line 106 such that the first panel 104A and the second panel 104B abut one another to at least partially enclose the prepaid card 114 therebetween. As such, it should be noted that the packaging 102 illustrated in FIG. 1A is in an unfolded state prior to folding the first panel 104A relative to the second panel 104B, or vice versa.

Based on the above, the first panel 104A and the second panel 104B may form an outer shell of the packaging 102 that houses the prepaid card 114 therebetween. The first panel 104A and/or the second panel 104B may include one or more layers (e.g., a composite material) or may be monolithically formed. Similarly, the first panel 104A and the second panel 104B may be integrally formed with one another. For example, the first panel 104A and the second panel 104B may die cut from a stock material and interconnected via the fold line 106 located therebetween. Additionally, it should be noted that the packaging 102 may contain any number of panels and is not particularly limited to the first panel 104A and the second panel 104B. For example, the packaging 102 may be a tri-fold configuration, whereby the packaging 102 may include the first panel 104A, the second panel 104B, and a third panel.

As described above, the first panel 104A and the second panel 104B may be interconnected by the fold line 106 to facilitate folding of the first panel 104A relative to the second panel 104B, or vice versa. The fold line 106 may be a crease or partial cut (e.g., scoring) within the first panel 104A and/or the second panel 104B to provide a flexible region between the first panel 104A and the second panel 104B.

The first panel 104A and/or the second panel 104B may define an aperture 108. The aperture 108 may provide a hanging mechanism to the packaging 102 so that the prepaid card assembly 100 may be hung from one or more display hooks. The aperture 108 of the first panel 104A and/or the aperture 108 of the second panel 104B may be any desired size and/or shape. When the first panel 104A and/or the second panel 104B are folded to contain the prepaid card 114, the aperture 108 of the first panel 104A may align with the aperture 108 of the second panel 104B such that a display hook may extend through both of the apertures.

It should be noted that the first panel 104A and/or the second panel 104B may contain one or images, text, numerical data, or a combination thereof. For example, the first panel 104A and/or the second panel 104B may contain a graphic, such as a gift box, to indicate the contents of the prepaid card assembly 100. Similarly, the first panel 104A and/or the second panel 104B may indicate a value of the prepaid card 114 located therein. Additionally, the first panel 104A and/or the second panel 104B may include a packaging barcode 122, whereby the packaging barcode 122 may be scanned by a retail establishment to inventory the prepaid card assembly 100, may be scanned during loading (i.e., purchasing) of the prepaid card 114, may be scanned during disposal of the prepaid card assembly 100 (e.g., if the retail establishment identifies that the prepaid card assembly 100 has been tampered with), or a combination thereof.

Turning back to FIG. 1A, the packaging 102 may define a cutout 116. For example, the first panel 104A and/or the second panel 104B may define a cutout 116 therein. As shown in FIG. 1A, the first panel 104A may define a cutout 116, whereby a barcode 118 of the prepaid card 114 may be at least partially visible through the cutout 116 so that the barcode 118 of the prepaid card 114 may be scanned (e.g., by the retail establishment) without removing the prepaid card 114 from the packaging 102. As such, the cutout 116 may also provide a window to visually confirm if the prepaid card 114 is present within the packaging 102.

The cutout 116 may be any desired size and/or shape. The cutout 116 may have dimensions smaller than dimensions of the prepaid card 114, may have dimensions smaller than dimensions of the barcode 118 of the prepaid card 114, or both. As such, the cutout 116 may vary in size based upon a size of the barcode 118 and/or a size of the prepaid card 114.

As described above, counterfeiting and tampering are common concerns within the prepaid card industry. That is, fraudsters may seek to duplicate genuine prepaid cards (e.g., the prepaid card 114) such that the duplicate or “dummy” prepaid card may replace the genuine prepaid card within the packaging 102. As a result, a genuine customer may select the prepaid card assembly 100 within the retail establishment and unintentionally load the dummy prepaid card instead of the genuine prepaid card, whereby the loaded funds may be inadvertently transferred to an account of the fraudster. While attempts have been made to combat such fraudulent activity, fraudsters have continued to counterfeit and tamper. For example, fraudsters may either replace the genuine prepaid card (e.g., the prepaid card 114) with the dummy prepaid card or, alternatively, may dispose a dummy barcode (e.g., a dummy barcode label) over the barcode 118 of the prepaid card 114.

To counteract such fraudulent activity, the prepaid card assembly 100 may implement one or more tamper-deterrent mechanisms, such as one or more tamper-deterrent mechanisms associated with the barcode 118. For example, as discussed above, the prepaid card 114 may include the barcode 118. The barcode 118 may be printed or otherwise secured to the prepaid card 114 such that the barcode 118 is entirely located on the prepaid card 114. That is, the barcode 118 may be located on the prepaid card 114 such that no portion of the barcode 118 is located or otherwise disposed on the packaging 102. However, in certain configurations, the barcode 118 may be at least partially disposed over a portion of the packaging (e.g., over a portion of the first panel 104A and/or the second panel 104B.

As shown in the close-up view of FIG. 1B, the barcode 118 of the prepaid card 114 may include a hologram 120 disposed on the barcode 118. The hologram 120 may provide a secondary visual inspection for a consumer and/or a retail establishment to identify that the barcode 118—and thus the prepaid card 114—is genuine. That is, the hologram 120 may function as a security measure to prevent counterfeit reproduction of the prepaid card 114 and/or tampering with the prepaid card 114.

The hologram 120 may be disposed directly over all or a portion of the barcode 118. For example, the hologram 120 may be applied to the barcode 118 as an adhesive layer or may be printed directly over the barcode 118. Advantageously, the hologram 120 may be printed over the barcode 118 such the barcode 118 may be scannable through the hologram 120. That is, the hologram 120 may be transparent or semi-transparent to facilitate such scanning of the barcode 118. It is envisioned that the hologram 120 may be any design, shape, size, color, or a combination thereof. By way of example, as shown in FIGS. 1A and 1B, the hologram 120 may be a series of circles varying in size that are disposed over substantially all of the barcode 118 of the prepaid card 114.

It is envisioned that the hologram 120 may provide an easy visual indication of tampering and/or counterfeiting. The hologram 120 may be reflective, translucent, or both. For example, the hologram 120 may appear to a consumer or retail establishment to have depth and may be viewed from different angles as if it were a physical object. That is, the hologram 120 may form or portray a three-dimensional image (e.g., via interference of light that may reflect off the hologram 120 from various angles) that visually stands out on the prepaid card 114. Additionally, due to the complexity of the hologram 120, it may be difficult for a fraudster to replicate the hologram 120, thereby further deterring tampering and/or counterfeiting.

By way of example, the hologram 120 may be considered a moving hologram. That is, the hologram 120 may exhibit motion or changes in perspective as a viewer of the hologram 120 alters their perspective or viewing angle of the hologram 120. The hologram 120 may contain multiple embedded images or frames that may be printed or disposed in a single holographic surface to form the hologram 120. Therefore, the hologram 120 may provide a dynamic visual indication such that the hologram 120 may appear to the user to move along the surface of the prepaid card 114.

It should be noted that the hologram 120 may be positioned anywhere relative to the barcode 118. For example, instead of being disposed directly over the barcode 118, the hologram 120 may be disposed on the prepaid card 114 adjacent to the barcode 118. However, as shown in FIG. 1A, it may be beneficial to position the hologram 120 on the prepaid card 114 such that the hologram 120 is viewable through the cutout 116 of the packaging 102.

In addition to the hologram 120, the barcode 118 may include one or more color gradients along at least a portion of the barcode 118 to vary colors of the barcode 118. The color gradients may alter a color of the barcode through one or more hues, one or more color shades, or both. For example, the barcode 118 may include a first portion that is purple and a second portion that is blue. The first portion and the second portion may be connected via a connecting region of the barcode 118, whereby the connecting region may include a plurality of different shades of color spanning between purple and blue. As a result, the barcode 118 may be more difficult to reproduce, thereby further deterring tampering and/or counterfeiting.

Turning back to FIG. 1A, the packaging 102 may also include a warning label 110 that is located adjacent to the barcode 118 of the prepaid card 114 when the prepaid card 114 is coupled to the packaging 102. For example, the warning label 110 may be disposed or printed on the first panel 104A adjacent to the cutout 116 of the packaging 102. The warning label 110 may include reference information 112 about the barcode 118 of the prepaid card 114 to identify counterfeit or tampered with packaging. For example, the warning label 110 may provide an easily identifiable feature to draw the consumer's eyes to the warning label 110 (e.g., a stop sign printed in red). As such, to alert the consumer or the retail establishment, the warning label 110 may include vibrant or bright colors, distinguished colors, include one or more patterns or shapes, or a combination thereof.

The warning label 110 may further include the reference information 112, whereby the reference information 112 may include a description of the barcode 118 to easily identify if the barcode 118 has been modified or tampered with. The reference information 112 may be configured to identify counterfeit or tampered with packaging (e.g., a tampered with prepaid card 114) based upon one or more features of the barcode 118 of the prepaid card 114. For example, the reference information 112 may include a description of one or more features of the barcode 118, such as the design of the hologram 120 printed on the barcode 118, a description of the color gradient of the barcode 118, or both.

It should be noted that the reference information 112 is not particularly limited to any type of information. For example, the reference information 112 may include text, numerical data, visual aids (e.g., one or more objects), colors, or a combination thereof. For example, the reference information 112 may include a reference barcode located in the warning label 110, whereby the reference barcode may be compared to the barcode 118 of the prepaid card 114. The reference barcode may include a similar hologram to the hologram 120 of the prepaid card 114 to compare a design of the hologram 120. The reference barcode may also include a similar color gradient for visual comparison. As such, the reference barcode may provide an easy comparison for the barcode 118. Similarly, the reference information 112 and thus the warning label 110 as a whole, may be located anywhere along the packaging 102.

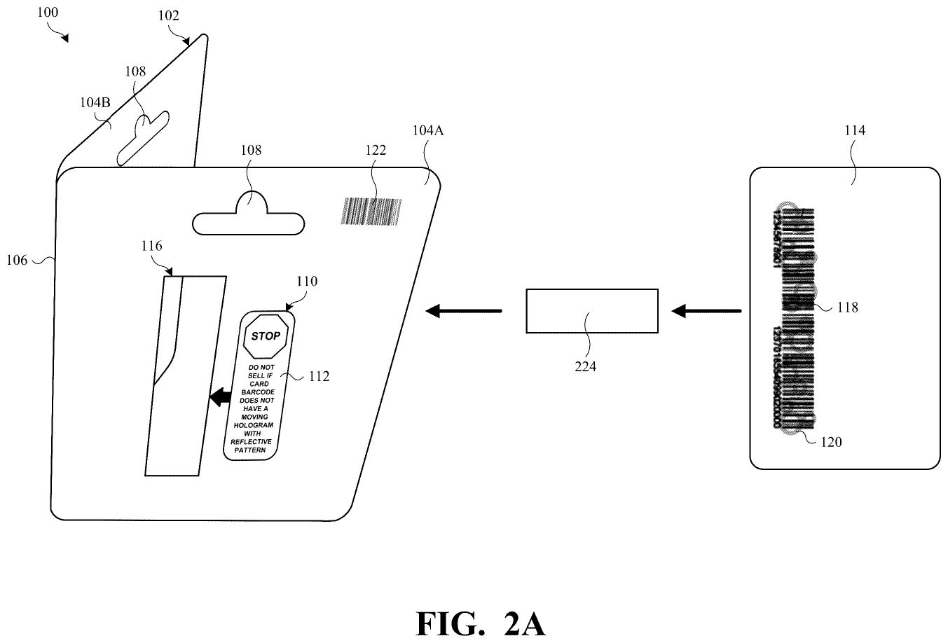

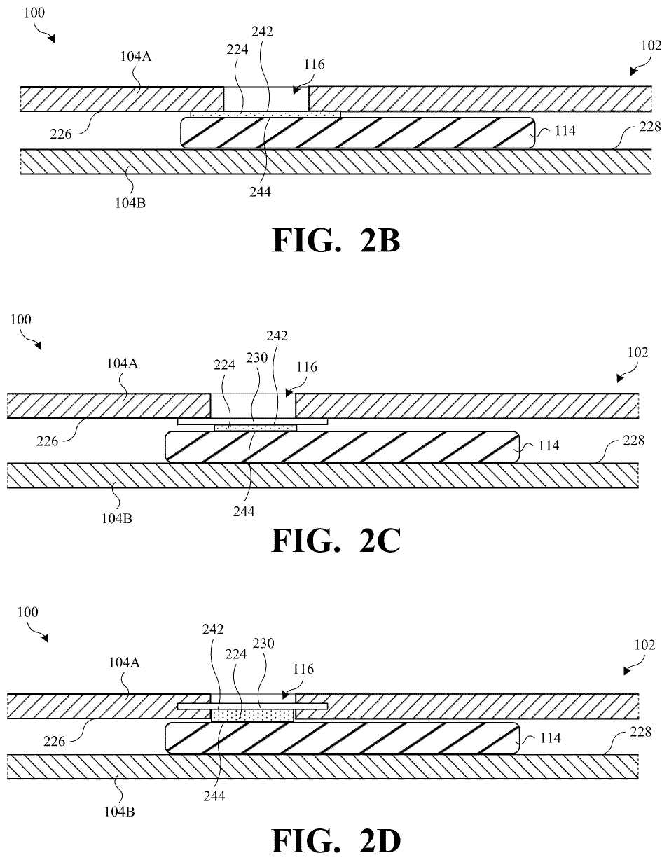

FIG. 2A illustrates a perspective view of the prepaid card assembly 100 of FIGS. 1A and 1B prior to insertion of the prepaid card 114 into the packaging 102 of the prepaid card assembly 100.

As discussed above, the prepaid card assembly 100 includes the packaging 102, whereby the packaging 102 includes the first panel 104A and the second panel 104B. The prepaid card 114 may be at least partially located between the first panel 104A and the second panel 104B. For example, the first panel 104A may be folded onto the second panel 104B along the fold line 106, whereby the prepaid card 114 is positioned therebetween. The packaging 102 may define the cutout 116 such that the barcode 118 of the prepaid card 114 is visible through the cutout 116 when the prepaid card 114 is coupled to the packaging 102. That is, the prepaid card 114 may be at least partially enclosed within and coupled to the packaging 102 such that the barcode 118 of the prepaid card 114 is visible through the cutout 116 of the packaging 102.

The prepaid card assembly 100 may also include the packaging barcode 122 disposed (e.g., printed) on the first panel 104A to provide an additional scannable portion of the prepaid card assembly 100. Moreover, the first panel 104A and the second panel 104B may each include an aperture 108 to facilitate hanging of the prepaid card assembly 100 for display in a retail establishment.

Furthermore, as described above with respect to FIGS. 1A and 1B, the prepaid card 114 may include the hologram 120 disposed over at least a portion of the barcode 118 such that the hologram 120 and the barcode 118 are visible through the cutout 116 when the prepaid card 114 is coupled to the packaging 102. Additionally, the packaging 102 may include a warning label 110 disposed (e.g., printed) on the first panel 104A and/or the second panel 104B, whereby the warning label 110 may include the reference information 112. The reference information 112 may be used to visually identify one or more features of the barcode 118, such as a color gradient of the barcode 118, a design of the hologram 120 (e.g., color of the hologram 120, shape of the hologram 120, location of the hologram 120, etc.), or both. As a result, the reference information 112 in combination with the hologram 120 may provide tamper-preventative and/or counterfeit-preventative mechanisms to the prepaid card assembly 100.

To further counter tampering and counterfeiting, the prepaid card 114 may be coupled to the packaging 102 such that, upon removal of the prepaid card 114 from the packaging 102, a portion of the barcode 118 of the prepaid card 114 may remain coupled to the packaging to render the barcode 118 of the prepaid card 114 unscannable. To facilitate such coupling of the prepaid card 114 to the packaging 102, the prepaid card assembly 100 may include an adhesive label 224.

As stated above, FIG. 2A illustrates the prepaid card assembly 100 prior to the prepaid card 114 being inserted and coupled to the packaging 102. The adhesive label 224 may be disposed between the packaging 102 and the prepaid card 114 to couple the prepaid card 114 to the packaging 102. For example, the adhesive label 224 may be disposed between the prepaid card 114 and the first panel 104A or the adhesive label 224 may be disposed between the prepaid card 114 and the second panel 104B.

To further illustrate exemplary locations of the adhesive label 224 within the prepaid card assembly 100, FIGS. 2B-2D illustrate cross-sectional views of the prepaid card assembly 100. The cross-sectional views of FIGS. 2B-2D are intended as illustrate examples only, and such configurations may illustrate that the positioning of the prepaid card 114 with respect to the adhesive label 224 and the packaging 102 may vary.

As shown in FIG. 2B, the prepaid card 114 may be disposed between the first panel 104A and the second panel 104B. In particular, the prepaid card 114 may be contained within the packaging 102 between an interior surface 226 of the first panel 104A and an interior surface 228 of the second panel 104B. The adhesive label 224 may be disposed over a portion of the prepaid card 114 so that the adhesive label 224 may couple the prepaid card 114 to the first panel 104A, such as to the interior surface 226 of the first panel 104A. As discussed further below, a portion of the adhesive label 224 may be located between the barcode 118 of the prepaid card 114 and the cutout 116. For example, as shown in FIG. 2B, the adhesive label 224 may extend beyond a perimeter of the cutout 116 so that the adhesive label 224 may be coupled to the interior surface 226 of the first panel 104A and extend across the cutout 116.

As shown in FIGS. 2C and 2D, the prepaid card assembly 100 may also include a cutout pane 230. The cutout pane 230 may be disposed over or otherwise located within the cutout 116 and may provide a window panel that covers the barcode 118 of the prepaid card 114. For example, as shown in FIG. 2C, the cutout pane 230 may be coupled to the interior surface 226 of the first panel 104A and extend beyond the confines of the cutout 116. In such a case, a first side 242 of the adhesive label 224 may be coupled directly to the cutout pane 230 and a second side 244 of the adhesive label 224 may be coupled to the prepaid card 114 to couple the prepaid card 114 to the cutout pane 230 and thus the first panel 104A.

Alternatively, as shown in FIG. 2D, the cutout pane 230 may be disposed within the cutout 116. The cutout pane 230 may be integrally formed with the first panel 104A and/or may be inserted into a slot of the first panel 104A. That is, the cutout pane 230 may be positioned outboard of the interior surface 226 of the first panel 104A, such as between the interior surface 226 of the first panel 104A and an exterior surface of the first panel 104A. As shown in FIG. 2D, the adhesive label 224 may again be coupled to the cutout pane 230 so that the prepaid card 114 may be coupled directly to the cutout pane 230.

The cutout pane 230 may be located anywhere along the packaging 102 to cover the cutout 116. The cutout pane 230 may be transparent or semi-transparent so that the barcode 118 of the prepaid card 114 is easily visible and scannable through the cutout 116 and the cutout pane 230. The cutout pane 230 may function as a protective cover to prevent unwanted debris and/or moisture from contacting the barcode 118 through the cutout 116. That is, the cutout pane 230 may prevent unwanted degradation to the barcode 118 that may prevent use of the barcode 118 as intended.

Additionally, the cutout pane 230 may be coupled to the packaging 102 in any desired manner so that the cutout pane 230 may remain coupled to the packaging 102 upon removal of the prepaid card 114 from the packaging 102. That is, an adhesive strength between the cutout pane 230 and the packaging 102 (e.g., the first panel 104A) may be greater than an adhesive strength between the adhesive label 224 and the cutout pane 230 and/or an adhesive strength between the adhesive label 224 and the prepaid card 114.

Thus, based on the above with respect to FIGS. 2B-2D, the prepaid card 114 may be coupled to the packaging 102 in a variety of manners using the adhesive label 224, such as via the cutout pane 230 or a surface of the first panel 104A and/or a surface of the second panel 104B.

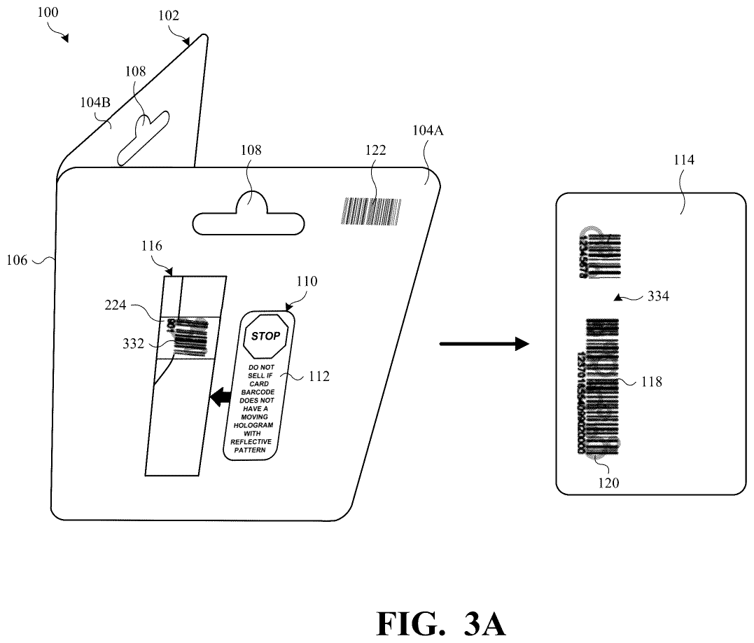

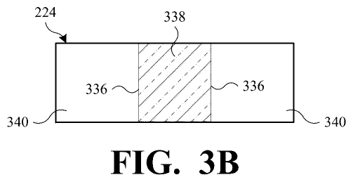

FIG. 3A is a perspective view of the prepaid card assembly 100 after removal of the prepaid card 114 from the packaging 102 of the prepaid card assembly 100.

As discussed above, the prepaid card assembly 100 includes the packaging 102, whereby the packaging 102 includes the first panel 104A and the second panel 104B. The prepaid card 114 may be at least partially located between the first panel 104A and the second panel 104B. For example, the first panel 104A may be folded onto the second panel 104B along the fold line 106, whereby the prepaid card 114 is positioned therebetween. The packaging 102 may define the cutout 116 such that the barcode 118 of the prepaid card 114 is visible through the cutout 116 when the prepaid card 114 is coupled to the packaging 102. That is, the prepaid card 114 may be at least partially enclosed within and coupled to the packaging 102 such that the barcode 118 of the prepaid card 114 is visible through the cutout 116 of the packaging 102.

The prepaid card assembly 100 may also include the packaging barcode 122 disposed (e.g., printed) on the first panel 104A to provide an additional scannable portion of the prepaid card assembly 100. Moreover, the first panel 104A and the second panel 104B may each include an aperture 108 to facilitate hanging of the prepaid card assembly 100 for display in a retail establishment.

Furthermore, as described above with respect to FIGS. 1A and 2A, the prepaid card 114 may include the hologram 120 disposed over at least a portion of the barcode 118 such that the hologram 120 and the barcode 118 are visible through the cutout 116 when the prepaid card 114 is coupled to the packaging 102. Additionally, the packaging 102 may include a warning label 110 disposed (e.g., printed) on the first panel 104A and/or the second panel 104B, whereby the warning label 110 may include the reference information 112. The reference information 112 may be used to visually identify one or more features of the barcode 118, such as a color gradient of the barcode 118, a design of the hologram 120 (e.g., color of the hologram 120, shape of the hologram 120, location of the hologram 120, etc.), or both. As a result, the reference information 112 in combination with the hologram 120 may provide tamper-preventative and/or counterfeit-preventative mechanisms to the prepaid card assembly 100.

As discussed above with respect to FIG. 2A, the prepaid card 114 may be coupled to the packaging 102 via the adhesive label 224. As shown in FIG. 3A, the prepaid card 114 may be coupled to the packaging 102 by the adhesive label 224 such that, upon removal of the prepaid card 114 from the packaging 102, the adhesive label 224 may be configured to remain coupled to the first panel 104A. Additionally, a portion 332 of the barcode 118 of the prepaid card 114 may be configured to remain coupled to the adhesive label 224 such that the barcode 118 of the prepaid card 114 may be unscannable. That is, once the prepaid card 114 is removed from the packaging 102, the barcode 118 of the prepaid card 114 may have a gap 334 therein, which may provide an even further indication of tampering and/or counterfeiting.

By way of example, a fraudster may seek to remove the prepaid card 114 to alter the barcode 118 (e.g., place a counterfeit barcode over the barcode 118 that may be tied to an account of the fraudster) or replace the prepaid card 114 entirely with a counterfeit prepaid card. However, the adhesive label 224 may be coupled to the prepaid card 114 over at least a portion of the barcode 118 of the prepaid card 114. Thus, upon removal of the prepaid card 114 from the packaging 102, the portion 332 of the barcode 118 of the prepaid card 114 may remain coupled to the adhesive label 224 such that the portion 332 of the barcode 118 may be visible through the cutout 116, even after the prepaid card 114 has been removed from the packaging 102.

As a result, even if the fraudster were to place a counterfeit barcode over the barcode 118 or replace the prepaid card 114 with a counterfeit prepaid card and then place the counterfeit prepaid card back into the packaging 102, the portion 332 of the barcode 118 may still be visible in the cutout 116, thereby providing a consumer or a retail establishment a visual indicator of the tampering and counterfeiting. Similarly, if a fraudster were to remove the prepaid card 114, the fraudster would be unable to scan the barcode 118 due to the gap 334 therein.

To facilitate the above intentional destruction of the barcode 118 after removal of the prepaid card 114 from the packaging 102, the adhesive label 224 may be configured to exhibit a desired adhesive strength. For example, an adhesive strength between the adhesive label 224 and the packaging 102 may be greater than an adhesive strength between the adhesive label 224 and the prepaid card 114 such that, when the prepaid card 114 is removed from the packaging 102, the adhesive label 224 may remain coupled to the packaging 102.

Additionally, to facilitate removal of the portion 332 of the barcode 118 during removal of the prepaid card 114 from the packaging 102, an adhesive strength between the barcode 118 and the adhesive label 224 may be greater than an adhesive strength or bonding strength (e.g., a printing bond of the barcode 118 on the prepaid card 114) between the barcode 118 and the prepaid card 114. For example, the prepaid card 114 may include a coating or friction modifier applied to a surface of the prepaid card 114 so that the barcode 118 may be removed from the prepaid card 114 due to an adhesive strength of the adhesive label 224.

It should be noted that the adhesive label 224 may also be coupled to the prepaid card 114 over at least a portion of the hologram 120. That is, the adhesive label 224 may be coupled to the prepaid card 114 over at least a portion of the barcode 118 and a portion of the hologram 120. As a result, the portion 332 of the barcode 118 removed from the prepaid card 114 during removal of the prepaid card 114 from the packaging 102 may also include at least a portion of the hologram 120. Therefore, a consumer or retail establishment may have a further enhanced visual indicator of tampering and/or counterfeiting.

As shown in FIG. 3A, the adhesive label 224 may be adhered to the packaging 102 in any desired location. The adhesive label 224 may extend across all of a portion of the cutout 116. In such a case, the adhesive label 224 may be joined (e.g., adhered) to portions of the first panel 104A, such as a portion of the interior surface 226 of the first panel 104A, adjacent to the cutout 116. Alternatively, the adhesive label 224 may be joined (e.g., adhered) to the packaging 102 such that the adhesive label 224 is free of obstruction of the cutout 116.

FIG. 3B illustrates a front view of the adhesive label 224. As discussed above, the adhesive label 224 may couple the prepaid card 114 to the packaging 102 such that a portion of the barcode 118 of the prepaid card 114 may remain coupled to the packaging 102 even after removal of the prepaid card 114 from the packaging 102.

The adhesive label 224 may be any desired material. For example, the adhesive label 224 may be made of polypropylene, polyethylene, polyester, or a combination thereof. The adhesive label 224 may be a vinyl label. The adhesive label 224 may contain or include any adhesive material. Additionally, the adhesive label 224 may be transparent or semi-transparent to facilitate easy viewing of the barcode 118 through the adhesive label 224.

The adhesive label 224 may include an adhesive pattern 338. The adhesive pattern 338 may be configured to adhere the adhesive label 224 to the prepaid card 114 (e.g., to the barcode 118 of the prepaid card 114). The adhesive pattern 338 may be any design or pattern. The adhesive pattern 338 may decrease or increase an adhesive strength of the adhesive label 224 within the region of the adhesive label 224 that contains the adhesive pattern 338. For example, the adhesive pattern 338 may decrease the adhesive strength such that the prepaid card 114 may release from the adhesive label 224 yet the adhesive label 224 may remain adhered to the packaging 102.

The adhesive pattern 338 may be located between packaging adhering regions 340 of the adhesive label 224. The packaging adhering regions 340 may adhere the adhesive label 224 to the packaging 102, such as the first panel 104A and/or the second panel 104B. Thus, the packaging adhering regions 340 may have an adhesive strength that is greater than the adhesive strength of the region of the adhesive label 224 that contains the adhesive pattern 338. The packaging adhering regions 340 may be free of the adhesive pattern 338. However, the packaging adhering regions 340 may be integrally formed with the region of the adhesive label 224 that contains the adhesive pattern 338.

By way of example, the packaging adhering regions 340 and the adhesive pattern 338 may be separated by one or more cut lines 336 of the adhesive label 224. The cut lines 336 may be a kiss cut or scoring located along the adhesive label 224 that may separate the packaging adhering regions 340 and the adhesive pattern 338. The cut lines 336 may further decrease an adhesive strength of the adhesive label 224 in the regions that contain the cut lines 336.

It should be noted that the adhesive pattern 338 and the packaging adhering regions 340 may be located on opposing sides of the adhesive label 224. For example, the second side 244 of the adhesive label 224 may include the adhesive pattern 338 that is configured to couple to the prepaid card 114 and the first side 242 of the adhesive label 224 that opposes the second side 244 may include the packaging adhering regions 340 to couple the adhesive label 224 to the packaging 102. Similarly, the adhesive label 224 may contain one or more regions that contain the adhesive pattern 338 and/or may include one or more of the packaging adhering regions 340.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A prepaid card assembly, comprising:
packaging; and
a prepaid card at least partially enclosed within the packaging, wherein the prepaid card includes a barcode,
wherein the prepaid card is coupled to the packaging such that, upon removal of the prepaid card from the packaging, a portion of the barcode of the prepaid card remains coupled to the packaging to render the barcode of the prepaid card unscannable.

2. The prepaid card assembly of claim 1, wherein the packaging defines a cutout, and the barcode of the prepaid card is visible through the cutout when the prepaid card is coupled to the packaging.

3. The prepaid card assembly of claim 1, wherein the packaging includes a warning label located adjacent to the barcode of the prepaid card when the prepaid card is coupled to the packaging, and the warning label includes reference information about the barcode of the prepaid card to identify counterfeit or tampered with packaging.

4. The prepaid card assembly of claim 1, wherein the prepaid card includes a hologram disposed on the barcode of the prepaid card, and the barcode of the prepaid card is configured to be scanned through the hologram.

5. The prepaid card assembly of claim 1, wherein the barcode of the prepaid card includes a color gradient to vary colors of the barcode.

6. The prepaid card assembly of claim 1, further comprising:
an adhesive label disposed between the packaging and the prepaid card to couple the prepaid card to the packaging.

7. The prepaid card assembly of claim 6, wherein the adhesive label is coupled to the prepaid card over at least a portion of the barcode of the prepaid card.

8. The prepaid card assembly of claim 7, wherein an adhesive strength between the adhesive label and the packaging is greater than an adhesive strength between the adhesive label and the prepaid card such that, when the prepaid card is removed from the packaging, the adhesive label remains coupled to the packaging.

9. The prepaid card assembly of claim 6, wherein the adhesive label includes an adhesive pattern located between packaging adhering regions of the adhesive label, the adhesive pattern is coupled to the prepaid card over at least a portion of the barcode of the prepaid card, and the packaging adhering regions are coupled to the packaging.

10. The prepaid card assembly of claim 9, wherein the packaging adhering regions are free of the adhesive pattern.

11. The prepaid card assembly of claim 9, wherein the packaging adhering regions and the adhesive pattern are separated by cut lines of the adhesive label.

12. A prepaid card assembly, comprising:
packaging that includes a first panel and a second panel;
a prepaid card at least partially located between the first panel and the second panel, wherein the prepaid card includes a barcode; and
an adhesive label disposed between the prepaid card and the first panel to couple the prepaid card to the packaging, wherein upon removal of the prepaid card from the packaging, the adhesive label is configured to remain coupled to the first panel and a portion of the barcode of the prepaid card is configured to remain coupled to the adhesive label such that the barcode of the prepaid card is unscannable.

13. The prepaid card assembly of claim 12, wherein the packaging defines a cutout, the barcode of the prepaid card is visible through the cutout when the prepaid card is coupled to the packaging, and a portion of the adhesive label is located between the barcode of the prepaid card and the cutout.

14. The prepaid card assembly of claim 12, wherein the prepaid card includes a hologram disposed on the barcode of the prepaid card, and the adhesive label is coupled to the prepaid card over at least a portion of the barcode of the prepaid card and the hologram.

15. The prepaid card assembly of claim 12, wherein an adhesive strength between the adhesive label and the packaging is greater than an adhesive strength between the adhesive label and the prepaid card such that, when the prepaid card is removed from the packaging, the adhesive label remains coupled to the packaging.

16. The prepaid card assembly of claim 13, wherein upon removal of the prepaid card from the packaging, the portion of the barcode of the prepaid card is configured to remain coupled to the adhesive label such that the portion of the barcode is visible through the cutout.

17. The prepaid card assembly of claim 12, wherein the packaging includes reference information about the barcode of the prepaid card and that is located adjacent to the barcode of the prepaid card when the prepaid card is coupled to the packaging, and the reference information is configured to identify counterfeit or tampered with packaging based upon one or more features of the barcode of the prepaid card.

18. The prepaid card assembly of claim 17, wherein the one or more features of the barcode of the prepaid card includes a color of the barcode of the prepaid card, a design of a hologram disposed over the barcode of the prepaid card, or both.

19. A prepaid card assembly, comprising:
packaging that defines a cutout;
a prepaid card at least partially enclosed within and coupled to the packaging, wherein the prepaid card includes a barcode, a hologram is disposed over at least a portion of the barcode, and the hologram and the barcode are visible through the cutout when the prepaid card is coupled to the packaging; and
an adhesive label disposed between the packaging and the prepaid card to couple the prepaid card to the packaging, wherein the adhesive label is coupled to at least a portion of the barcode of the prepaid card such that, upon removal of the prepaid card from the packaging, the portion of the barcode of the prepaid card is removed from the prepaid card and remains coupled to the packaging.

20. The prepaid card assembly of claim 19, wherein upon removal of the prepaid card from the packaging, the portion of the barcode of the prepaid card remains visible through the cutout.
